(19) United States
(12) Patent Application Publication
(10) Pub. No.: US 2005/0223706 A1
(43) Pub. Date: Oct. 13, 2005

(54) HYDRAULIC POWERTRAIN SYSTEMS FOR A VEHICLE INCLUDING HYDRAULICALLY AND AUXILIARY POWERED SYSTEMS AND ACCESSORIES

(76) Inventors: Herman R. Mitchell, Dayton, OH (US); Donald H. Ochs, Piqua, OH (US)

Correspondence Address: ARTZ & ARTZ, P.C., 28333 TELEGRAPH RD., SUITE 250, SOUTHFIELD, MI, 48034, US

(21) Appl. No.: 10/907,513

(22) Filed: Apr. 4, 2005

Related U.S. Application Data
(63) Continuation-in-part of application No. 10/906,270, filed on Feb. 11, 2005.
Application No. 10/906,270 is a continuation-in-part of application No. 10/718,160, filed on Nov. 20, 2003, now Pat. No. 6,862,885.
(60) Provisional application No. 60/587,575, filed on Jul. 13, 2004.

(51) Int. Cl. F02B 33/44

(52) U.S. Cl. 60/606

(57) ABSTRACT

A hydraulic auxiliary power system (248) for a vehicle includes a hydraulic pump (28). An auxiliary drive motor (56′) receives hydraulic fluid from the hydraulic pump (28). An electrical current generating device (252) is coupled to the auxiliary drive motor (56′) and powers one or more mechanically or electrically operated devices (254). A powertrain system (10′″) includes an engine (12) and the hydraulic pump (28). A drivetrain hydraulic motor (30) receives hydraulic fluid from the hydraulic pump (28). The drivetrain motor (30) supplies energy for translation of the vehicle in response to the received hydraulic fluid. The auxiliary drive motor (56′) is in fluid operation with the hydraulic pump (28) and supplies energy to one or more of the mechanically or electrically powered devices (254).

### RELATED APPLICATION

The present application is a continuation-in-part of U.S. patent application Ser. No. 10/906,270, filed on Feb. 11, 2005, entitled “HYDRAULIC POWERTRAIN SYSTEMS FOR A VEHICLE INCLUDING HYDRAULICALLY AND AUXILLARY POWERED AIR INJECTION”, which is incorporated by reference herein. The U.S. patent application Ser. No. 10/906,270 is a continuation-in-part of U.S. patent application Ser. No. 10/718,160, filed on Nov. 20, 2003, entitled “AIR INJECTION APPARATUS FOR A TURBOCHARGED DIESEL ENGINE”. The present application also claims priority to U.S. Provisional Application Ser. No. 60/587,575, entitled “Energy Optimization of a System”, which is also incorporated by reference herein.

### TECHNICAL FIELD

The present invention relates to engines equipped with or without exhaust-driven turbochargers and to hydraulic drive powertrain systems. More particularly, the present invention is related to efficient hydraulic powertrain systems with auxiliary power sources for various systems and accessories.

### BACKGROUND OF THE INVENTION

High power engines are commonly equipped with exhaust-driven turbochargers that increase engine output power by boosting the intake air pressure, and hence the density of the air/fuel mixture in the engine cylinders. Turbocharging can also be used to reduce soot emissions when the engine is operated at higher-than-stoichiometric air/fuel ratios, albeit at the expense of thermodynamic efficiency. Unfortunately, turbocharging also tends to increase the formation of oxides of nitrogen (NOx) due to the increased exhaust gas temperature in the exhaust manifold, and is relatively ineffective at low engine speeds. Accordingly, what is needed is a way of reducing exhaust emissions in an engine without sacrificing engine operating efficiency, while at the same time improving turbocharger performance at low engine speeds to make the engine suitable for high torque, low speed operation.

There also exists a need for a hydraulic powertrain system having improved efficiency and thus fuel economy, that is feasible for various vehicle applications, that provides increased functionality when at rest or in an idle condition, and that improves operator awareness of current vehicle status information.

### SUMMARY OF THE INVENTION

One embodiment of the present invention provides a hydraulic auxiliary power system for a vehicle that includes a hydraulic pump. An auxiliary drive motor receives hydraulic fluid from the hydraulic pump. An electrical current generating device is coupled to the auxiliary drive motor and powers one or more mechanically or electrically operated devices.

Another embodiment of the present invention provides a powertrain system that includes an engine and the hydraulic pump. A drivetrain hydraulic motor receives hydraulic fluid from the hydraulic pump. The drivetrain motor supplies energy for translation of the vehicle in response to the received hydraulic fluid. An auxiliary drive motor is in fluid operation with the hydraulic pump and supplies energy to one or more mechanically or electrically powered devices.

The embodiments of the present invention provide several advantages. One such advantage is the provision of a hydraulic powertrain system having a hydraulically driven auxiliary drive motor for operation of a generator or the like. The use of the auxiliary drive motor allows for operation of various mechanical and electrical devices and systems. These systems may be operated while the vehicle is parked and in an idle state.

Another advantage of the present invention is the inclusion of an external electrical power source circuit, which allows for the reception of electrical power for operation of various mechanical and electrical devices and systems without vehicle engine operation.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a schematic and block diagrammatic view of a vehicle hydraulic powertrain system in accordance with an embodiment of the present invention.

FIG. 2 is a schematic and block diagrammatic view of the air injection portion of the powertrain system of FIG. 1.

FIG. 3 is a schematic and block diagrammatic view of a vehicle hydraulic powertrain system illustrating a sample single turbocharger configuration in accordance with another embodiment of the present invention.

FIG. 4 is a schematic and block diagrammatic view of a vehicle hydraulic powertrain system illustrating a sample single supercharger configuration in accordance with yet another embodiment of the present invention.

FIG. 5 is a logic flow diagram illustrating a method of operating a vehicle hydraulic powertrain system in accordance with an embodiment of the present invention;

FIG. 6 is a schematic and block diagrammatic view of a vehicle hydraulic powertrain system incorporating an hydraulic auxiliary power system in accordance with an embodiment of the present invention.

FIG. 7 is a logic flow diagram illustrating a method of operating a hydraulic powertrain system in accordance with another embodiment of the present invention.

### DETAILED DESCRIPTION

The present invention is disclosed herein primarily in the context of a roadway vehicle such as a truck equipped with a continuously variable hydrostatic drive. However, it will be understood that the invention is also useful both in other vehicular applications and in non-vehicular applications such as power generation stations.

In the following description, various operating parameters and components are described for one constructed embodiment. These specific parameters and components are included as examples and are not meant to be limiting.

The present invention includes an engine, such as a turbocharged diesel engine, in which a high flow of above-atmospheric pressure air is injected into the engine exhaust manifold at distributed locations to simultaneously improve engine power output, exhaust emissions and fuel efficiency. In a sample embodiment, the injected air is provided by a supercharger, at a flow rate of approximately 100-250 cubic feet per minute (CFM). The injected air provides greatly increased exhaust airflow at low engine speeds to dramatically increase the turbocharger boost pressure, which increases engine power output. Improved low speed power output is beneficial in nearly any application including applications, such as a vehicle hydrostatic drive applications, in which the engine is operated at a low and substantially constant speed. The engine exhaust emissions are improved because the injected air: (1) reduces the gas temperature in the exhaust manifold well below the temperature at which NOx emissions are formed; (2) promotes more complete combustion of the air/fuel mixture in the engine to reduce soot; and (3) promotes secondary combustion in the exhaust manifold to reduce other exhaust emissions such as carbon monoxide (CO) and hydrocarbons (HC). The reduction of exhaust emissions through secondary combustion, in turn, allows the engine air fuel ratio to be operated closer to the ideal stoichiometric air/fuel ratio for improved thermodynamic efficiency. The engine fuel efficiency is further improved in constant speed applications, such as in continuously variable hydrostatic drive applications, where losses associated with the acceleration and the deceleration of the engine are minimized.

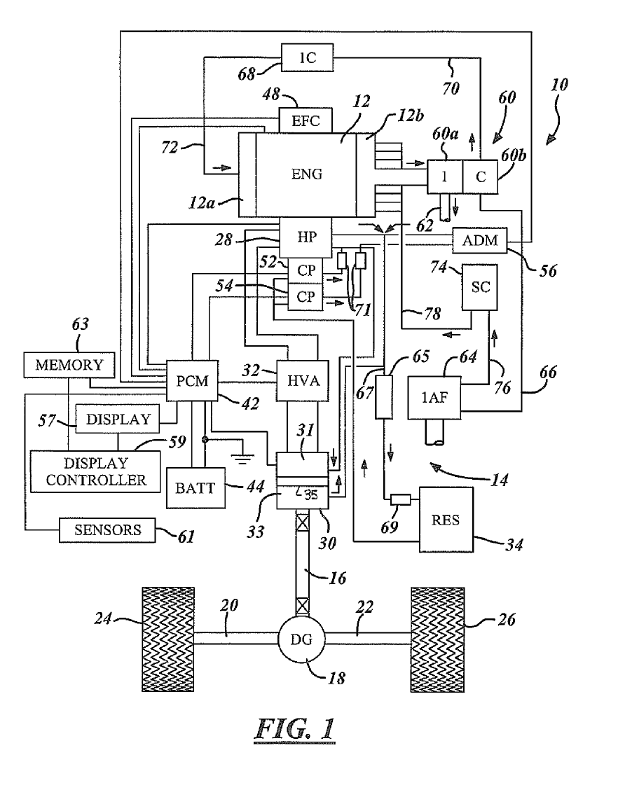

Referring now to FIG. 1, the reference numeral 10 generally designates a hydraulic powertrain system that includes an engine (ENG) 12 and a hydrostatic drive 14. The engine 12 may be in the form of a diesel engine, a combustion engine, a hydraulic engine, an electric engine, or other engines or motors known in the art. The hydrostatic drive 14 couples the power output of the engine 12 to a drive arrangement that includes a driveshaft 16, a differential gearset (DG) 18, drive axles 20, 22 and drive wheels 24, 26.

The hydrostatic drive 14 primarily includes a variable capacity main hydraulic pump (HP) 28 that is driven by the engine 12, a hydraulic drive motor (DM) 30 is coupled to the driveshaft 16, and to a hydraulic valve assembly (HVA) 32. The DM 30 includes two or more hydraulic motors that are ganged together. The ganging of the motors to each other and the coupling of the motors between the DG 18 and the HP 28 provides efficient energy transfer to the drive axles 20, 22. The hydraulic motors may be in a dual arrangement, a tandem arrangement, or in a sequencing arrangement. A dual arrangement refers to the use of two hydraulic motors as primarily described herein. A tandem arrangement refers to the direct coupling of the hydraulic motors in series. A sequencing arrangement refers to the ability to select one or more of the hydraulic motors for operation in any combination and the ability to control the timing thereof.

In one embodiment, the DM 30 includes a first drive motor and a second drive motor that are ganged together in series without use of a gearset. The PCM 42 may control the timing between the drive motors 31, 33 relative to each other to provide efficient coupling therebetween and to prevent undesired harmonic generation due to improper synchronization. The first drive motor 31 is mounted to the second drive motor 33 via a block 35. The first drive motor is configured and designed for high torque, low speed operation, while the second drive motor is designed for low torque, high speed operation. The drive motors may be operated separately or in combination, such as to provide increased torque at low speeds or when starting from rest or from a zero velocity state. The drive motors may be controlled electronically and/or in response to hydraulic fluid received therefrom. The drive motors may be variable displacement motors.

In a sample embodiment of the present invention, a first drive motor operates in response to an electrical signal received from a controller internal or external to the DM 30 and a second drive motor operates in response to hydraulic fluid received from the first drive motor. The electrical signal may be generated in response to engine speed, throttle position, and vehicle speed. The controller may be the below described PCM 42, may be part of the DM 30, or may be some other vehicle controller. The engine speed, throttle position, and vehicle speed may be acquired from the sensors 61, also described below. Each drive motor within the DM 30 may have an associated controller for controlling displacement thereof.

In another sample embodiment, a first drive motor is operated continuously throughout translation of the corresponding vehicle, such as during both low-speed and high-speed operation, and a second drive motor is selectively operated as desired. This provides increased torque at “take-off” or low speeds when under increased load. This minimizes the amount of activation and deactivation of drive motors and provides desired fuel efficiency.

In general, the HP 28 supplies fluid to the DM 30 by way of HVA 32, while directing a portion of the fluid to a reservoir 34. Note that the DM 30 is not supplied by high-pressure hydraulic fluid stored within a high-pressure accumulator. The hydraulic powertrain system 10 in not using a high-pressure accumulator provides an efficient hydraulic powertrain system that is lighter and can provide improved fuel efficiency. High-pressure hydraulic fluid stored in a high-pressure accumulator is generally or approximately at a fluid pressure greater than 1000 psi. The HP 28, the DM 30, and the HVA 32 are operated by the powertrain control module (PCM) 42. The combination of the HP 28, the HVA 32, the DM 30, and the PCM 42 may be referred to as a hydrostatic continuously variable transmission. The HVA 32 includes a number of solenoid-operated valves that are selectively energized or deenergized to control fluid flow.

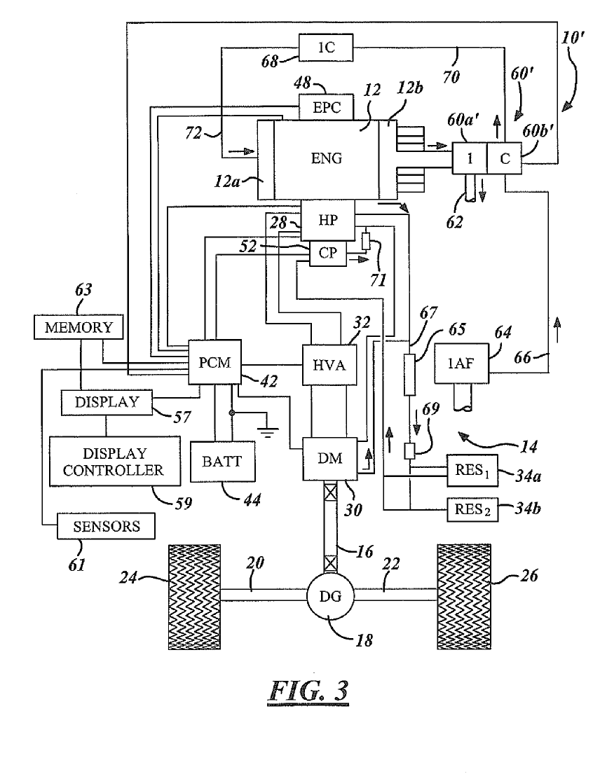

The reservoir 34 is a low-pressure reservoir and is used to store and hold hydraulic fluid. The hydraulic fluid within the reservoir 34 is at a pressure of approximately less than 100 psi. The reservoir 34 may be a single reservoir as shown or may be divided up into multiple stand-alone reservoirs that may be in various vehicle locations. An example dual reservoir system is shown with respect to the embodiment of FIG. 3 in which a first reservoir 34a and a second reservoir 34b are shown.

The PCM 42 is powered by a vehicle storage battery 44, and may include a micro-controller for carrying out a prescribed control of the DM 30 and the HVA 32. The PCM 42 is also coupled to hydraulic pump 28 for controlling its pumping capacity, and to an engine fuel controller (EFC) 48 for controlling the quantity of fuel injected into the cylinders (not shown) of the engine 12. In a particularly advantageous mechanization, PCM 42 controls the capacity of hydraulic pump 28 to satisfy the vehicle drive requirements, while controlling EFC 48 to maintain a low and substantially constant engine speed such as 1000 RPM. The PCM 42 may control the HP 28 and the DM 30 independently, individually, simultaneously, or otherwise to provide a desired or predetermined torque output for a given engine speed for desired traction of the wheels 24, 26.

The PCM 42 and the EFC 48 may be microprocessor based such as a computer having a central processing unit, memory (RAM and/or ROM), and associated input and output buses. The PCM 42 and the EFC 48 may be application-specific integrated circuits or may be formed of other logic devices known in the art. The PCM 42 and the EFC 48 may be a portion of a central vehicle main control unit, an interactive vehicle dynamics module, a control circuit having a power supply, may be combined into a single integrated controller, or may be stand-alone controllers as shown.

The PCM 42 continuously monitors various inputs of the engine 12, the HP 28, and the DM 30 including the speed and torque of the engine 12 and the hydrostatic transmission 14 to electronically manage and simultaneously operate the powertrain system 10 using the lowest energy input. The PCM 42 controls several outputs in response to the inputs including fuel input of the engine 12, displacement of the HP 28, displacement of the DM 30, efficiency curve information, percent engine load, accelerator pedal position, pressures of the HP 28 and DM 30, as well as other various parameters of the powertrain system 10. It is desired that the engine 12 operate at a maximum engine load for a given rpm. The HP 28 and the DM 30 are efficient at their maximum swash plate positions and at desired pressure ranges. The PCM 42 provides such control to achieve desired efficiencies. The configuration of the powertrain system 10, the components utilized therein, and the control methodology provided within the PCM 42 allow for efficient system operation at start, stop, and through various drive modes that allow for the non-use of a high-pressure accumulator.

The hydrostatic drive 14 additionally includes first and second charge pumps (CP) 52, 54 that are ganged together with the HP 28. The charge pumps 52, 54 are driven by the engine 12. The first charge pump 52 supplies control pressure to HP 28 and DM 30 from reservoir 34, and the second charge pump 54 supplies hydraulic fluid from reservoir 34 to an auxiliary hydraulic drive motor (ADM) 56, described below. The charge pumps supply hydraulic fluid at moderate pressures approximately between 100-1000 psi. The charge pumps 52, 54 prevent cavitation of and maintain low friction operation of the HP 28, the DM 30, and the ADM 56. Although two charge pumps are shown any number of charge pumps may be utilized.

The PCM 42 is also coupled to a display 57, which may be operated via a display controller 59, and to sensors 61 and memory 63. The display 57 may be used to indicate to a vehicle operator system pressures, temperatures, maintenance information, warnings, diagnostics, and other system related information. The maintenance information may, for example, include oil life, filter life, pump performance parameters, hydraulic motor performance parameters, engine performance parameters, and other maintenance related information. The display 57 and the display controller 59 may also indicate or provide data logging and historical data for diagnostics including system pressure, system temperature, oil life, maintenance schedule information, system warnings, as well as other logging and historical data.

The display controller 59 displays the stated information in response to data received from the sensors 61 or retrieved from the memory 63. The memory 63 may store the above stated information, as well as other vehicle systems related information known in the art. The memory 63 may be in the form of RAM and/or ROM, may be an integral portion of the PCM 42 or the display controller 59, may be in the form of a portable or removable memory, and may be accessed using techniques known in the art.

The display may be in the form of one or more indicators such as LEDs, light sources, audio generating devices, or other known indicators. The display may also be in the form of a video system, an audio system, a heads-up display, a flat-panel display, a liquid crystal display, a telematic system, a touch screen, or other display known in the art. In one embodiment of the present invention, the display 57 is in the form of a heads-up display and the indication signal is a virtual image projection that may be easily seen by the vehicle operator. The display 57 provides a real-time image system status information without having to refocus ones eyes to monitor a display screen within the vehicle.

The display controller 59 may, for example, be in the form of switches or a touch pad and be separate from the display 57, as shown. The display controller 59 may be an integral part of the display 57 and be in the form of a touch screen or other display controller known in the art. The display controller 59 may also be microprocessor based such as a computer having a central processing unit, memory (RAM and/or ROM), and associated input and output buses. The display controller 59 may be application-specific integrated circuits or may be formed of other logic devices known in the art. The display controller 59 may be a portion of a central vehicle main control unit, such as the PCM 42, an interactive vehicle dynamics module, a control circuit having a power supply, may be combined into a single integrated controller, or may be a stand-alone controller as shown.

The sensors 61 may include pressure sensors, temperature sensors, oil sensors, flow rate sensors, position sensors, engine speed sensors, vehicle speed sensors, throttle position sensors, as well as other vehicle system sensors known in the art. In one embodiment of the present invention a pressure sensor, a temperature sensor, and a flow rate sensor are used to indicate the pressure, temperature, and flow rate of the hydraulic fluid received by the DM 30.

The hydrostatic system 14 may also include a heat exchanger 65 for cooling of the hydraulic fluid within return line 67. Cooling of the hydraulic fluid aids in providing efficient operation of the hydrostatic system 14 and increases operating life of the components and devices contained therein. The heat exchanger 65 may be of various types and styles and may be located in various locations within a vehicle. The heat exchanger 65 may be in the form of an air-to-oil heat exchanger or a liquid-to-oil heat exchanger. Thus, the heat exchanger may be cooled by air and/or by a liquid coolant, such as water, propylene glycol, or other coolant or a combination thereof. The heat exchanger 65 may be associated solely with the cooling of hydraulic fluid within the return line 67 or may be used for cooling of other fluids. In one embodiment of the present invention, the heat exchanger 65 is shared and is used to cool hydraulic fluid within the hydrostatic system 14, as well as oil within the engine 12. The heat exchanger 65 may be in the form of a radiator and may be cooled by a fan (not shown).

The hydrostatic system 14 may further include particulate filters with various pressure ratings. In the embodiment shown a low-pressure return line filter 69 is coupled between the reservoir 34 and the heat exchanger 65 and is used to filter the hydraulic fluid in return line 67. Charge pump filters 71 are coupled between the charge pumps 52, 54 and the HP 28, the DM 30, and the ADM 56, respectively, and are used to filter hydraulic fluid entering the HP 28, the DM 30, and the ADM 56. The charge pump filters 71 are rated for higher fluid pressures than that of the low-pressure filter 69. Although a specific number of filters are shown, any number of filters may be utilized.

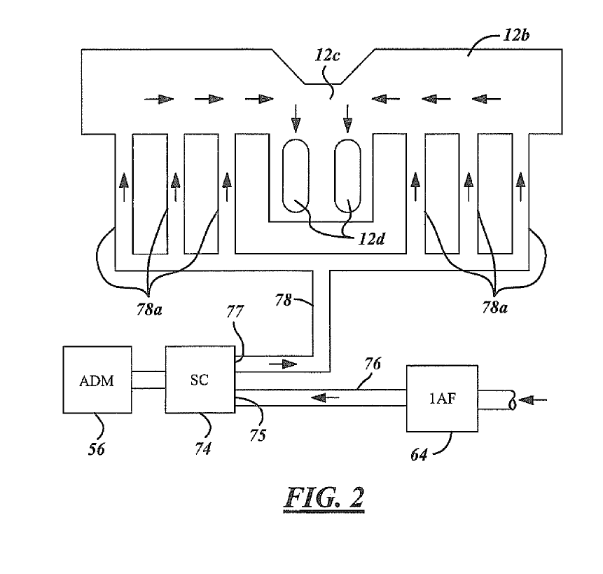

Referring now also to FIG. 2, the engine 12 includes an intake manifold 12a that receives intake air. An exhaust manifold 12b collects the engine cylinder exhaust gases. FIG. 2 illustrates the exhaust manifold 12b of a typical diesel engine having an in-line cylinder configuration. The cylinder exhaust gases are discharged into the left and right portions or runners of the exhaust manifold 12b, and are channeled toward a central collection plenum 12c with one or more exit ports 12d. In a typical application, the left-hand and right-hand portions of the exhaust manifold 12b may be separate castings that are individually bolted to the engine 12. In any event, the exhaust gas exit ports 12d lead to the impeller section (1) 60a of an exhaust-driven turbocharger 60 en route to an exhaust pipe or header 62. The impeller section 60a drives a compressor section (C) 60b of the turbocharger 60, which compresses atmospheric pressure air for delivery to the intake manifold 12a. The inlet atmospheric pressure air passes through an inlet air filter (IAF) 64, and is delivered to the compressor section 60b via low-pressure conduit 66. The high-pressure air at the outlet of compressor section 60b is passed though an intercooler 68 by the conduits 70, 72 en route to the intake manifold 12a.

In a conventional turbocharged diesel engine, the gas temperature in the exhaust manifold is well above 1700° F., the temperature above which NOx emissions are readily formed. Moreover, since a conventional turbocharger produces little boost at low engine speeds, the air/fuel ratio in the engine cylinders becomes too rich when the fuel delivery is increased to accelerate the engine. As a result, partially consumed fuel is discharged into the exhaust manifold, producing objectionable levels of soot until the engine speeds up and the turbocharger produces sufficient boost. The high levels of soot formation and the low speed power deficiency can be addressed by some external means that speeds up the turbocharger impeller. The increased speed of the turbocharger impeller provides the intake air boost needed, but at the expense of increased NOx formation due to high cylinder and exhaust manifold temperatures and long residence times. The embodiment described below with respect to FIG. 2, on the other hand, provides an approach that not only achieves low speed soot and power improvements, but also achieves significant improvements in NOx emissions and fuel economy.

A mechanically driven supercharger (SC) 74 delivers high-pressure air to the exhaust manifold 12b at distributed locations along its length. The inlet air is passed through an inlet air filter 64 (which may be the same inlet air filter used by the turbocharger 60, or a different inlet air filter), and is delivered to the supercharger inlet 75 by a conduit 76. The supercharger outlet 77 is coupled to a high-pressure plenum 78 from which a number of branches 78a inject the air into distributed locations of the exhaust manifold 12b, at an approximate flow rate of 100-250 CFM. In one embodiment, the number of branches 78a is equal to the number of engine cylinders discharging exhaust gases into the manifold 12b, and the air is injected in proximity to the points at which the exhaust gases are discharged into the manifold 12b. The temperature of the air injected into exhaust manifold 12b by supercharger 74 is approximately 307° F., effectively cooling the exhaust gasses to approximately 350° F., which is well below temperatures at which NOx emissions are readily formed. Interestingly, this also has the effect of reducing the required cooling capacity of the liquid coolant that is circulated through the engine 12, thereby reducing the engine power requirements for coolant pumping and radiator airflow.

In the illustrated embodiment, the supercharger 74 is driven by a hydraulic accessory drive motor (ADM) 56 powered by hydraulic fluid from charge pump 54 as mentioned above. This is particularly advantageous in the context of a hydrostatic vehicle drive since the additional hydraulic fluid pressure for powering the supercharger 74 is available at very little extra cost, and the capacity of ADM 56 can be controlled by the PCM 42 as indicated to optimize the rotational speed of the supercharger 74 regardless of the engine speed. Furthermore, the supercharger 74 may be located remote from the engine 12 as implied in FIGS. 1-2, which allows the supercharger 74 to be mounted in a location that provides cooler inlet air and easier mounting and routing of the air conduits. Of course, the supercharger 74 can alternatively be driven by a different rotary drive source such as an electric or pneumatic motor, or the engine 12.

In summary, the air injection system of the present invention simultaneously contributes to improved exhaust emissions, engine power output and fuel efficiency, and allows a turbocharged diesel engine to be well suited to highly efficient low constant speed operation in a hydrostatic vehicle drive.

Referring now to FIG. 3, a schematic and block diagrammatic view of a vehicle hydraulic powertrain system 10′ illustrating a sample single turbocharger configuration in accordance with another embodiment of the present invention is shown. The powertrain system 10′ is similar to the powertrain system 10, however the turbocharger 60 is replaced with a high-efficiency turbocharger 60′, which eliminates the need for the supercharger 74 and associated componentry. The turbocharger has impeller 60a′ and compressor 60b′. The turbocharger 60′ may be configured for efficient operation at low constant engine speeds. The engine speed is controlled by the PCM 42 such that a low constant speed is maintained.

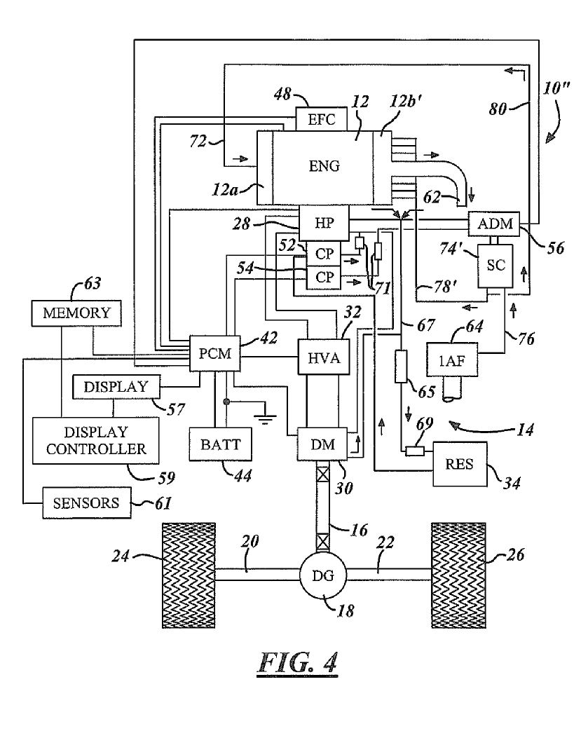

Referring now to FIGS. 4, a schematic and block diagrammatic view of a vehicle hydraulic powertrain system 10″ illustrating a sample single supercharger configuration in accordance with another embodiment of the present invention is shown. The powertrain system 10″ is also similar to the powertrain system 10. However a supercharger 74′ is utilized in replacement of the supercharger 74 and is configured to supply air to the intake manifold 12a. In supplying air to the intake manifold 12a the turbocharger 60 is not utilized and is thus removed. Also, since the supercharger 74′ does not draw air from the exhaust manifold 12b′ the intercooler 68 is also eliminated. The plenum 78′ includes an additional branch 80 over that of the plenum 78, which supplies the air to the intake manifold 12a. The exhaust manifold 12b′ is also modified to couple directly to the header or exhaust pipe 62.

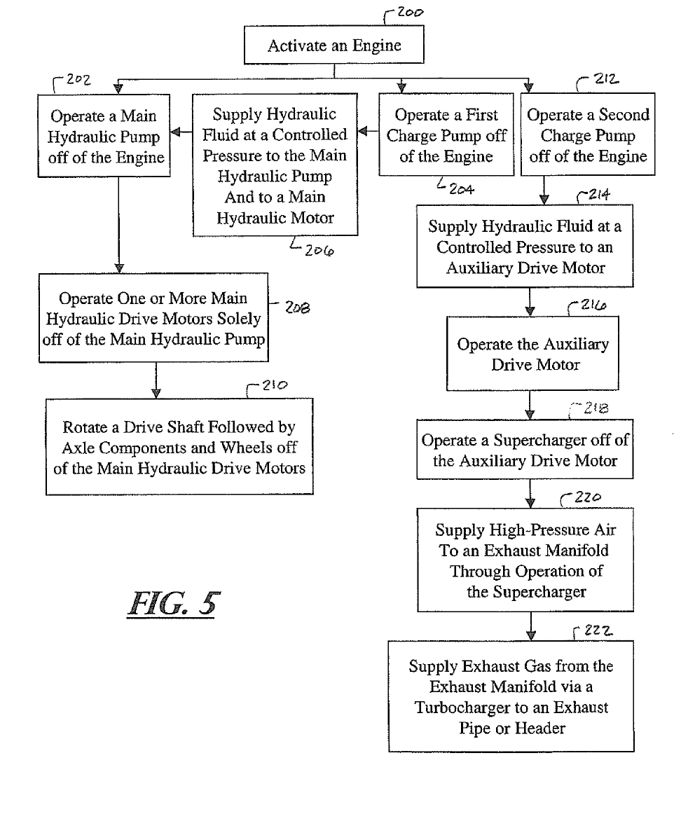

Referring now to FIG. 5, a logic flow diagram illustrating a method of operating a vehicle hydraulic powertrain system in accordance with an embodiment of the present invention is shown. Although steps 200-222 are described primarily with respect to the embodiments of FIGS. 2 and 3, the method of FIG. 4 may be easily modified for other embodiments of the present invention.

In step 200, an engine is activated, such as the engines 12. The engine may be activated via the PCM, or by other methods known in the art.

In step 202, a main hydraulic pump, such as the HP 28, is operated or driven directly off of the engine. The main hydraulic pump may be coupled to a crankshaft of the engine and receive rotational energy therefrom.

In step 204, a first charge pump, such as the CP 52, is also operated off of the engine. The first charge pump may be ganged to the main hydraulic pump and also operate in response to rotation of a crankshaft of the engine. In step 206, the first charge pump supplies control pressure to the main hydraulic pump and to a main hydraulic motor, such as the DM 30. In steps 204 and 206, the first charge pump may be operated and the control pressure may be adjusted by a PCM, such as the PCM 42. The control pressure may also be adjusted mechanically within the charge pump.

In step 208, one or more main hydraulic motors, such as the motors of the DM 30, are operated off of high-pressure hydraulic fluid received from the main hydraulic pump. The flow direction of the high-pressure hydraulic fluid may be adjusted by a hydraulic valve assembly, such as the hydraulic valve assembly.

In step 210, a driveshaft followed by components of an axle assembly and the corresponding wheels of a vehicle are rotated in response to rotational energy received from the main hydraulic motors. Components of an axle assembly may refer to, for example, the DG 18 and the axles 20 and 22. With respect to the embodiment of FIG. 1, the DM 30 rotates the driveshaft 16, the DG 18, the axles 20, 22, and the wheels 24, 26 for translation of the corresponding vehicle in a forward or reverse direction.

In step 212, a second charge pump, such as the CP 54, is operated similarly as the first charge pump. In step 214, the second charge pump supplies hydraulic fluid to an auxiliary drive motor, such as the ADM 56, at a controlled pressure, which may also be adjusted by the a PCM or internally controlled.

In step 216, the auxiliary drive motor is activated and operated utilizing the hydraulic fluid received from the second charge pump. The auxiliary drive motor may also be activated and operated via a PCM, such as the PCM 42.

In step 218, a supercharger, such as the supercharger 218, is operated off of the auxiliary drive motor. In step 220, the supercharger draws air through an intake filter and injects it into an exhaust manifold. In step 222, a turbocharger, such as the turbocharger 60, is operated in response to exhaust received from the exhaust manifold. The turbocharger directs and or injects exhaust gas into an intake manifold and into an exhaust pipe.

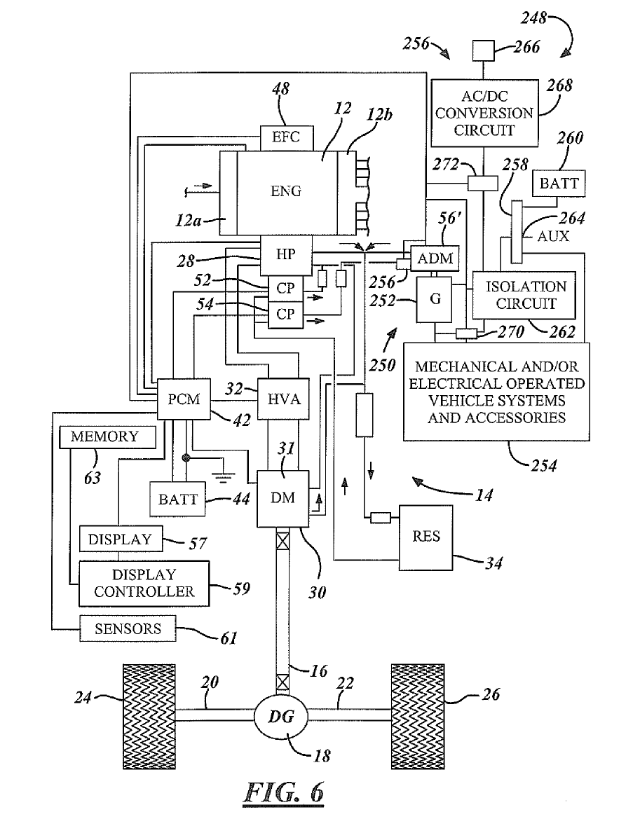

Referring now to FIG. 6, a schematic and block diagrammatic view of a vehicle hydraulic powertrain system 10′″ incorporating a hydraulic auxiliary power system 248 in accordance with an embodiment of the present invention is shown. The auxiliary power system 248 includes the HP 28 and an auxiliary power circuit 250. The auxiliary power circuit 250 has one or more auxiliary drive motors 56′ (only one is shown), which power one or more electrical current generating devices (only one is shown) 252. The current generating devices 252 supply electrical current to various mechanical and/or electrical operated vehicle systems and accessories 254. An external electrical power source circuit 256 is coupled to and may be used in addition to or in replacement of the ADMs 56′ and the current generating devices 252.

Although a single auxiliary power circuit is shown, any number may be utilized. When multiple auxiliary power circuits are utilized, each circuit may be associated with one or more of the mechanical/electrical devices 254. The auxiliary power circuit 250 may be in various arrangements and configurations. The auxiliary power circuit 250 may include auxiliary drive motors and associated devices operating in parallel or in series. Each auxiliary drive motor may be operated separately or in a parallel configuration with respect to associated mechanical and electrical devices or may be coupled or ganged in series. A single auxiliary drive motor may be utilized to operate one or more mechanical devices and one or more electrical current generating devices. For example, a single auxiliary drive motor may be utilized to operate a supercharger and an electrical generator. In addition, a first auxiliary drive motor may be utilized to operate one or mechanical devices and a second auxiliary drive motor may be utilized to operate a current generating device, which in turn operates one or more electrical devices. The stated arrangements and configurations, as well as others will become more apparent upon review of the below description.

The ADMs 56′ are similar to the ADM 56, but include one or more valve assemblies 256 (only one is shown) that may be part of or coupled to the ADMs 56′. The ADMs 56′ receives and operates off of hydraulic fluid received from the second charge pump 54 and/or other charge pumps not shown. Each of the charge pumps may be associated with one or more of the ADMs 56′. The ADMs 56′ and the valve assembly 256 are coupled to the PCM 42. The valve assembly 256 may be used to control the volume, pressure, and flow rate of the hydraulic fluid entering the ADMs 56′. Although the valve assembly 256 is shown and described with respect to the embodiment of FIG. 6, it may also be utilized in other embodiments of the present invention, including the embodiments previously stated above.

The current generating devices 252 may be in the form of generators, alternators, or other electrical current generating devices known in the art. The current generating devices 252 may include an AC generator and/or a DC generator.

The mechanical/electrical devices 254 may include an air injection blower, an air injection supercharger, an air-conditioning system, a heating, ventilation, and air-conditioning (HVAC) system, a power steering system, an air conditioning compressor, a refrigeration compressor, an air compressor, a water pump, a fuel pump, an oil pump, a fan, an engine cooling fan, a hydrostatic drive system cooling fan, an auxiliary hydraulic pump, a parasitic engine device, electronic accessories, such as audio/video systems, lights, navigation systems, global positioning systems, dashboard and operator indicator systems, and various other mechanical and electrical operated devices. Of course, when powering a mechanical device, an electrical motor or the like may be used and reside between the current generating devices 252 and the mechanical device of concern. The electrical motor may be an integral part of the mechanical device. For example, a power steering pump, although having components that are mechanically rotated or actuated, may have an associated electrical motor that converts electrical energy received from the current generating devices 252 into mechanical energy to operate the pump. The mechanical/electrical devices 254 may also include any device that is powered via use of belts or power take-offs.

The current generating devices 252 may supply power directly to the mechanical/electrical devices 254 or to a main power bus 258, which is coupled thereto and to a power source 260. The current generating devices 252 may supply AC and/or DC current. The power source 260 may be in the form of one or more vehicle batteries, as shown. An isolation circuit 262 may reside between and be used to separate the current generating devices 252, the external power source circuit 256, and the main power bus 258. The isolation circuit may include AC-to-DC isolation and DC-to-DC isolation circuitry known in the art. The current generating devices 252 may supply power to and/or for the mechanical/electrical devices 254 mentioned or to an auxiliary power output 264 for powering devices within or external to a vehicle.

The external power source circuit 256 may include an external adaptor 266 for reception of AC power, such as for example that commonly received from a 110V or 220V AC power outlet. The external adaptor 266 is coupled to an AC/DC conversion circuit 268, which converts the received AC current into DC current for storing on the power source 260 or for utilization by the mechanical/electrical devices 254.

The auxiliary power circuit 250 may include one or more power adjustment and conditioning circuits. The conditioning circuits may be utilized to adjust power, current, or voltage output of the current generating devices 252 or of the power source circuit 256. A first conditioning circuit 270 is shown as residing between the current generating devices 252 and the isolation circuit 262 and a second conditioning circuit 272 is shown as residing between the power source circuit 256 and the isolation circuit 262. The isolation circuit 262 and the conditioning circuits 270, 272 may be coupled to and controlled by the PCM 42.

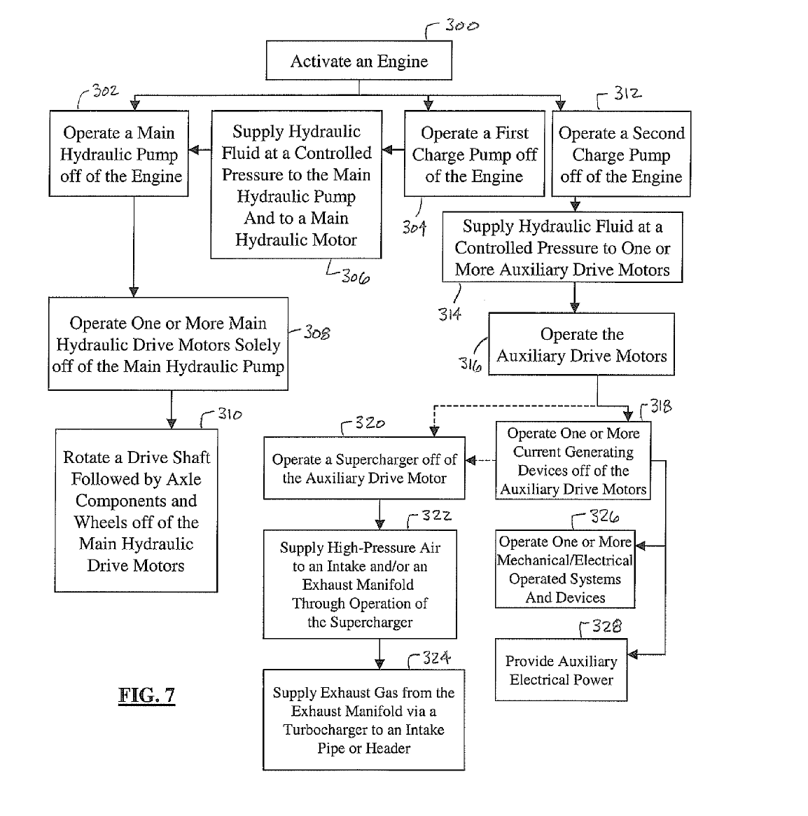

Referring now to FIG. 7, a logic flow diagram illustrating a method of operating a hydraulic powertrain system in accordance with another embodiment of the present invention is shown. Steps 300-312 are similar to steps 200-212 above. The method described with respect to FIG. 7 is provided as a sample illustration, is described primarily with the embodiment of FIG. 6, and is not meant to be all encompassing. The steps described below may also be easily modified for other embodiments of the present invention.

In step 314, hydraulic fluid is supplied at a controlled pressure to one or more auxiliary drive motors, such as the ADMs 56′. The hydraulic fluid received by the auxiliary drive motors may be from one or more charge pumps, such as the charge pump 54.

In step 316, the auxiliary drive motors are operated in response to the received hydraulic fluid and/or in response to a control signal. The control signal may be received from a controller, such as the PCM 42. In step 318, one or more current generating devices, such as the current generating devices 252, are operated in response to power received from the auxiliary drive motors.

As generally indicated by step 320, a mechanical device, such as a supercharger, may be operated in response to power received directly from the auxiliary drive motors or from the current generating devices. In step 322, the supercharger supplies high-pressure air to an intake header and/or to an exhaust manifold. In step 324, a turbocharger, such as the turbocharger 60, may be utilized to supply exhaust gas to an intake manifold. Step 324 may be performed in replacement of or simultaneously with step 322.

In step 326, one or more mechanical and/or electrical systems and devices, such as systems and devices 254, may be operated in response to power received from the current generating devices, a main power bus, a power supply, and/or an external electrical power source circuit, such as the current generating devices 252, the main power bus 258, the power source 260, and the power source circuit 256, respectively. In step 328, auxiliary power is provided via one or more auxiliary power outputs, such as the auxiliary power output 264.

The above-described steps in the methods of FIGS. 5 and 7 are meant to be illustrative examples; the steps may be performed sequentially, synchronously, simultaneously, or in a different order depending upon the application.

The present invention provides a hydraulic powertrain system having a hydraulic auxiliary power system that is at least partially powered via hydraulic energy. The hydraulic auxiliary power system uses hydraulic energy to power one or more mechanical and electrical operated devices and in so doing provides design system and application versatility. The hydraulic auxiliary power system is capable of operating while an associated engine is at idle, thereby, minimizing fuel consumption.

While the invention has been described in reference to the illustrated embodiments, it should be understood that various modifications in addition to those mentioned above will occur to persons skilled in the art. Accordingly, it will be understood that systems incorporating these and other modifications may fall within the scope of this invention, which is defined by the appended claims.

1. A hydraulic auxiliary power system for a vehicle comprising:
at least one hydraulic pump;
at least one auxiliary drive motor receiving hydraulic fluid from said at least one hydraulic pump; and
at least one electrical current generating device coupled to said at least one auxiliary drive motor and powering at least one device within a set comprising a plurality of mechanically operated devices and a plurality of electrically operated devices.

2. A system as in claim 1 wherein said at least one hydraulic pump comprises a main hydraulic pump that provides energy to a main hydraulic motor for rotation of vehicle wheels.

3. A system as in claim 1 wherein said at least one hydraulic pump comprises at least one charge pump supplying a controlled pressure of hydraulic fluid to at least one of said at least one hydraulic pump and said at least one auxiliary drive motor.

4. A system as in claim 1 wherein said at least one auxiliary drive motor comprises a single auxiliary drive motor that supplies energy to at least two of said at least one electrical current generating device.

5. A system as in claim 1 wherein said at least one electrical current generating device comprises a single electrical current generating device that supplies energy to a plurality of devices within said set.

6. A system as in claim 1 wherein said at least one auxiliary drive motor and said at least one electrical current generating device comprises:
a first auxiliary drive motor supplying energy to a first electrical current generating device; and
a second auxiliary drive motor supplying energy to a second electrical current generating device.

7. A system as in claim 1 wherein said at least one electrical current generating device comprises:
a first electrical current generating device providing energy to said plurality of mechanical devices; and
a second electrical current generating device providing energy to said plurality of electrical devices.

8. A system as in claim 1 wherein said at least one electrical current generating device provides mechanical energy to a supercharger.

9. A system as in claim 1 wherein said at least one electrical current generating device supplies power to at least one device selected from an air injection blower, an air injection supercharger, an air conditioning system, an air conditioning compressor, a refrigeration compressor, an air compressor, a water pump, a fuel pump, an oil pump, a fan, an engine cooling fan, a hydrostatic drive system cooling fan, an auxiliary hydraulic pump, and a parasitic engine device.

10. A system as in claim 1 further comprising a controller controlling energy generated from said at least one electrical current generating device.

11. A system as in claim 1 further comprising an external electrical power source circuit in electrical operation with said at least one electrical current generating device and supplying electrical energy to the at least one of the electrically powered systems and accessories.

12. A system as in claim 11 wherein said external electrical power source circuit comprises:
an electrical adaptor for connection to a vehicle external power source;
an AC/DC circuit coupled to said electrical adaptor; and
an isolation circuit coupled between said AC/DC circuit and said at least one electrical current generating device.

13. A system as in claim 12 further comprising:
an energy adjustment circuit coupled to said AC/DC conversion circuit; and
a controller coupled to said energy adjustment circuit and adjusting energy received from said external circuit.

14. A system as in claim 1 further comprising:
a energy adjustment circuit coupled to said at least one electrical current generating device; and
a controller coupled to said energy adjustment circuit and adjusting energy received from said at least one electrical current generating device.

15. A system as in claim 1 further comprising a valve assembly coupled between said at least one hydraulic pump and said at least one auxiliary drive motor.

16. A hydraulic powertrain system for a vehicle comprising:
an engine;
at least one hydraulic pump coupled to said engine; and
at least one hydraulic motor in fluid operation with said hydraulic pump and comprising;
at least one drivetrain hydraulic motor supplying energy for translation of the vehicle in response to a received hydraulic fluid from said at least one hydraulic pump; and
at least one auxiliary drive motor supplying energy to at least one device within a set comprising a plurality of mechanically powered devices and a plurality of electrically powered devices.

17. A system as in claim 16 wherein said at least one hydraulic pump comprises:
a main drivetrain hydraulic pump supplying said hydraulic fluid to said at least one drivetrain hydraulic motor; and
at least one charge pump supplying a controlled pressure of hydraulic fluid to at least one of said at least one hydraulic pump and said at least one hydraulic motor.

18. A system as in claim 16 wherein said at least one auxiliary hydraulic motor supplies energy to at least one electrical current generating device, which in turn supplies energy to at least one device within said set.

19. A method of operating a hydraulic powertrain system of a vehicle comprising:
powering at least one hydraulic pump via an engine of the vehicle;
operating at least one auxiliary drive motor in response to hydraulic fluid received from said at least one hydraulic pump; and
converting mechanical energy received from said at least one auxiliary drive motor to electrical energy to operate at least one of a plurality of electrically powered systems and accessories.

20. A method as in claim 19 further comprising translating the vehicle in response to energy received from said at least one hydraulic pump.
